(19) United States
(12) Patent Application Publication
(10) Pub. No.: US 2007/0135101 A1
(43) Pub. Date: Jun. 14, 2007

(54) Enhanced visual IVR capabilities

(75) Inventors: Nadav Ramati, Modi'in (IL); Nir Henn, Ramat Hasharon (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 11/296,257

(22) Filed: Dec. 8, 2005

(51) Int. Cl. H04Q 7/38

(52) U.S. Cl. 455/414.1; 379/88.18

(57) ABSTRACT

A multi-modal user interface method and system enabling a user of a cellular telephone being connected to a cellular network via both a voice connection and a data connection to receive a menu in both an audible manner and a visual manner, during the course of the call and substantially simultaneously.

### FIELD AND BACKGROUND OF THE INVENTION

The present invention relates to interactive voice response systems and services and similar systems providing services to cellular telephones and to similar mobile devices.

Interactive Voice Response (IVR) is a generic name for information services provided over the telephone network. As its name applies, the service interacts with the user by playing voice prompts and subsequent information. The IVR service is provided by an IVR system, connected to the telephone network. The IVR service may be operated by the telephone service company or by any client of the telephone company that operates an IVR system. The user terminal is mostly a regular telephone. The user controls the service mostly by keystrokes on the telephone keypad and sometimes by verbal commands using voice recognition as the service ends. IVR services have started over the Public Switched Telephone Network (PSTN) and developed into the Public Land Mobile Network (PLMN) and especially into the cellular network. Hence, the user terminals for IVR services have also developed from simple telephone terminals into sophisticated devices such as the third generation cellular telephones and wireless Personal Digital Assistant (PDA) devices.

Originally the term IVR referred to a service enabling a user to interactively select and retrieve personal information from a database, while the Audiotex service enabled a user to retrieve non-personal information, and the voicemail service enabled the user to retrieve voice messages that were left in the user's voice mailbox. Other services employing voice interaction range from the Auto-Attendant service that routes callers to a specific telephone extension, to call-center services, currently known as customer resource management (CRM), that provide preliminary interaction between a caller and a telephone service center.

With the continuous development of computer controlled services provided over the telephone network (also known as CTI) the term IVR expanded to cover computer controlled voice interaction over the telephone network, irrespective of what the service may be.

A typical IVR operates a hierarchical set of menus. The service plays to the user a menu as voice prompt and the user responds with a keystroke (or a verbal keyword). Hence, in current IVR based systems and services, all the information is provided to the user in audible form. This information includes menus, request for specific entry, such as the user identification, password, etc. and the retrieved information. Providing information in audible form is advantageous when the visual attention of the user is required for other duties, such as driving. However, providing information in audible form is disadvantageous in noisy environment and for the hearing impaired. Additionally, the user must memorize the audible information while it is played, which is obviously a limiting factor on the amount of information that can be provided. While it is possible to request the IVR service to repeat the information it usually impossible to retain it for a later use.

Display menus are also known in the prior art and are extensively used by cellular telephones for the display of information relating to current calls, and to display of useful information to the user and management and configuration of the telephone features. Communicating textual information to the display of the cellular telephone is also known in the prior art and is extensively used in short message service (SMS).

A system and a method for integration of the visual display of the menus for IVR systems has been suggested by Susman in US patent application 2003/0074198, which is incorporated herein by reference. However, Susman refers to wireline telephones and wired networks. Susman teaches a special display telephone terminal that connects to the IVR system via the circuit switched PSTN, and, concurrently, via the packet switched Internet. Thus, this prior art solution requires the concurrent use of two unrelated wireline networks and is obviously inappropriate for a mobile telephone that has access to neither.

There is thus a need for, and it would be highly advantageous to have, a system and method for providing human interface for IVR services devoid of the above limitations.

### SUMMARY OF THE INVENTION

According to one exemplary embodiment of the present invention there is provided a cellular telephony user interface method for enabling a user of a cellular telephone connecting to a cellular network via both a voice connection and a data connection to make a selection from a menu of options, the method comprising: transmitting the menu of options as data via the data link during the course of a call involving the voice connection, and, further during the course of said call, converting the data bearing the menu into a graphical format and displaying the graphical format on a display of the cellular telephone.

According to another exemplary embodiment of the present invention there is provided a cellular telephony user interface method wherein the graphical format includes a text menu.

According to yet another exemplary embodiment of the present invention there is provided a cellular telephony user interface method wherein the graphical format includes at least one icon.

According to still another exemplary embodiment of the present invention there is provided a cellular telephony user interface method wherein the menu is transmitted down the data link using Unstructured Supplementary Service Data (USSD).

Further according to another exemplary embodiment of the present invention there is provided a cellular telephony user interface method wherein the selection is performed within a service provided via the cellular telephone, the method additionally including providing the menu to the user in an audible manner via the voice connection simultaneously with the visual presentation and accepting the selection of either the visually sensible manner or the audible manner.

Still further according to another exemplary embodiment of the present invention there is provided a cellular telephony user interface method wherein each of the user selectable options is provided simultaneously in the audible manner and in the visually sensible manner.

According to another exemplary embodiment of the present invention there is provided a cellular telephony user interface method wherein the audible manner includes a voice menu played via an earphone of the cellular telephone.

Additionally according to another exemplary embodiment of the present invention there is provided a cellular telephony user interface method wherein the visually sensible manner includes a text menu displayed on a display of the cellular telephone.

According to another exemplary embodiment of the present invention there is provided a cellular telephony user interface method wherein the visually sensible manner includes a graphical menu displayed on a display of cellular telephone.

According to yet another exemplary embodiment of the present invention there is provided a cellular telephony user interface method wherein the graphical menu includes at least one icon.

According to still another exemplary embodiment of the present invention there is provided a cellular telephony user interface method wherein the menu provided in a visually sensible manner is transmitted to the cellular telephone via Unstructured Supplementary Service Data (USSD).

According to still another exemplary embodiment of the present invention there is provided a cellular telephony user interface method wherein the networked-based service is a voice mail service, an interactive voice response service, an audiotex service, and/or a multimedia service.

According to still further another exemplary embodiment of the present invention there is provided a cellular telephony user interface method for enabling a user to make a selection from a menu including a plurality of user selectable options, the method comprising: providing the menu to the user as a streaming media, providing the menu to the user as a non-streaming media simultaneously with the streaming media, and accepting the selection by the user of at least one of the options in response to at least one of the streaming and non-streaming media.

Additionally according to another exemplary embodiment of the present invention there is provided a cellular telephony user interface system operative to enable a user of a cellular telephone to make a selection from a menu comprising: a plurality of user selectable options, the system including an application-processing unit operative to provide the menu to a user and to process the selection from the user, a signaling unit associated with the application-processing unit, operative to transmit content of the menu to the cellular telephone, and a user client for the cellular telephone, and operative to process the transmitted menu and to produce a visually sensible menu on a display of the cellular telephone, wherein the signaling apparatus is operative to transmit the menu to the user client at the cellular telephone via Unstructured Supplementary Service Data (USSD).

Further according to another exemplary embodiment of the present invention there is provided a cellular telephony user interface system operative to enable a user of a cellular telephone to make a selection from a menu comprising: a plurality of user selectable options, the system including an application-processing device operative to provide the menu and to process the selection when received from the user, a voice streaming device operative to receive the menu from the application-processing device and to transmit at least one voice prompt associated with the menu to the user via the cellular telephone, a signaling device operative to receive the menu from the application-processing device and to transmit the menu to the cellular telephone via a data link and to receive the selection from the cellular telephone for passing back to the application-processing device, and a user client for provision to the cellular telephone, operative to receive the menu via the data link and to produce a visually sensible menu on a display of the cellular telephone and to receive the user's selection and send the selection back to the signaling apparatus.

Further according to another exemplary embodiment of the present invention there is provided a cellular telephony user interface method wherein the voice streaming device and/or the signaling device receive(s) the menu from the application-processing device using VoiceXML.

According to another exemplary embodiment of the present invention there is provided a cellular telephony user interface method wherein the voice streaming device and/or the signaling device receive(s) the menu from the application-processing device using Simple Object Access Protocol (SOAP).

According to another exemplary embodiment of the present invention there is provided a cellular telephony user interface method in which the cellular telephone receives the menu via the data link using Unstructured Supplementary Service Data (USSD).

According to yet another exemplary embodiment of the present invention there is provided a cellular telephony user interface system wherein the visually sensible manner is transmitted to the cellular telephone via Unstructured Supplementary Service Data (USSD).

Additionally according to another exemplary embodiment of the present invention there is provided a cellular telephone comprising: a user client, the user client including a data input unit for receiving data from a data link during the course of a voice call, a menu extraction unit associated with the data input unit for extracting menu data from the data link, a menu display unit associated with the menu extraction unit and with a screen of the cellular telephone, for displaying extracted menu data graphically on the screen during the course of the voice call, and a menu response unit for identifying user input as a selection from the menu and outputting the user's selection.

According to another exemplary embodiment of the present invention there is provided a cellular telephone wherein the data input unit receives the menu via the data link using Unstructured Supplementary Service Data (USSD).

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system involves performing or completing certain selected tasks or operations manually, automatically, or a combination thereof. Moreover, according to actual instrumentation and equipment of preferred embodiments of the method and system, several selected operations could be implemented by hardware or by software on any operating system of any firmware or a combination thereof. For example, as hardware, selected operations could be implemented as a chip or a circuit. As software, selected operations could be implemented as a plurality of software instructions executed by a computer using any suitable operating system. In any case, selected operations of the method and system could be implemented as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for an understanding of the invention, the description taken with the drawings making apparent to those skilled in the art how the several forms of the invention may be embodied in practice.

In the drawings:

FIG. 1 is a simplified illustration of a PLMN network equipped with a mobile-applications platform providing a multi-modal user interface according to a preferred embodiment of the present invention;

FIG. 2 is a simplified illustration of the PLMN network equipped with a privately operated mobile-applications platform according to another preferred embodiment of the present invention;

FIG. 3 is a simplified diagram of a sequence of multi-modal transmissions of service prompts and a user's response according to a preferred embodiment of the present invention;

FIG. 4 is a simplified diagram of a typical call flow between the user cellular telephone and the mobile application platform providing multi-modal user interface according to a preferred embodiment of the present invention;

FIG. 5 is a simplified diagram of the typical call flow between the user cellular telephone and the mobile application platform providing multi-modal user interface, including the MSC and the base station, and according to a preferred embodiment of the present invention;

FIG. 6 is a simplified, yet more detailed, illustration of the mobile-applications platform providing multi-modal user interface of FIG. 5;

FIG. 7, is a simplified block diagram of the user client module executed by the cellular telephone according to a preferred embodiment of the present invention FIG. 8 is a simplified flow chart of the call flow between the main modules of the mobile-applications platform according to a preferred embodiment of the present invention;

FIG. 9 is a simplified, yet more detailed, flow chart of the call flow of FIG. 7;

FIG. 10 is a simplified diagram of a call flow involving transmitting a visual menu to a mobile phone during the course of a call involving a voice connection according to a preferred embodiment of the present invention;

FIG. 11 is a simplified, yet more detailed, illustration of the mobile-applications platform supporting transmitting a visual menu to a mobile phone during the course of a call involving a voice connection according to a preferred embodiment of the present invention;

FIG. 12 is a simplified flow chart of the call flow between the main modules of the mobile-applications platform and the cellular telephone of FIG. 11; and

FIG. 13 is a simplified, yet more detailed, flow chart of the call flow of FIG. 12.

### DESCRIPTION OF THE PREFERRED EMBODIMENTS

The present embodiments comprise a method and a system to provide users of cellular telephones and similar mobile communication devices with a multi-modal user interface. Preferred embodiments can provide a user interface, which simultaneously uses audible presentation, such as a voice prompt, and visual presentation such as a text display. The audible presentation is provided via the circuit switched voice connection in the usual way, and data for the visual representation is preferably provided by the telephone's data connection, for example using the USSD standard. The USSD data is then rendered into visual format using a client program at the receiving mobile telephone.

The two presentations are preferably presented simultaneously to the user so that the user has the choice of listening at the earphone or looking at the user's screen as the user selects options at the interface.

The principles and operation of a multi-modal user interface according to exemplary embodiments may be better understood with reference to the drawings and accompanying description.

Before explaining various exemplary embodiments in detail, it is to be understood that the invention is not limited in its application to the details of construction and the arrangement of the components set forth in the following description or illustrated in the drawings. The invention is capable of other embodiments and of being practiced or carried out in various ways.

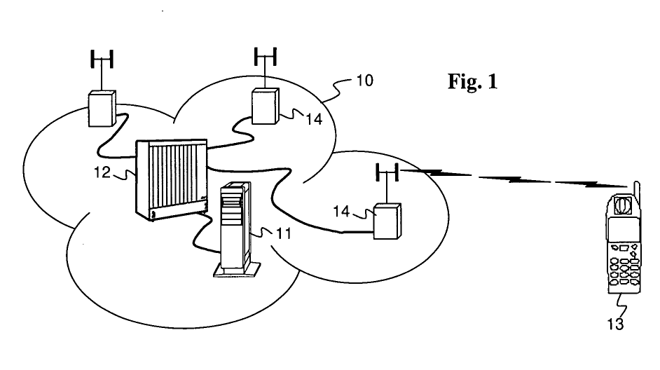

Reference is now made to FIG. 1, which is a simplified illustration of a PLMN network 10 equipped with a mobile-applications platform 11 providing a multi-modal user interface according to a preferred embodiment. As shown in FIG. 1, network-based mobile-applications platform 11 is connected to a mobile switching center (MSC) 12. A user of a cellular telephone 13 can access the mobile-applications platform 11 via a base-station 14 and the MSC 12. It is appreciated that alternatively element 12 can be a visiting location register (VLR) or a home location register (HLR).

The mobile-applications platform 11 provides various services to the user of the cellular telephone 13. These services are typically interactive, typically involving prompts and menus to which the user responds. The user preferably responds using keystrokes or by speaking keywords, as is preferably suggested by the prompt.

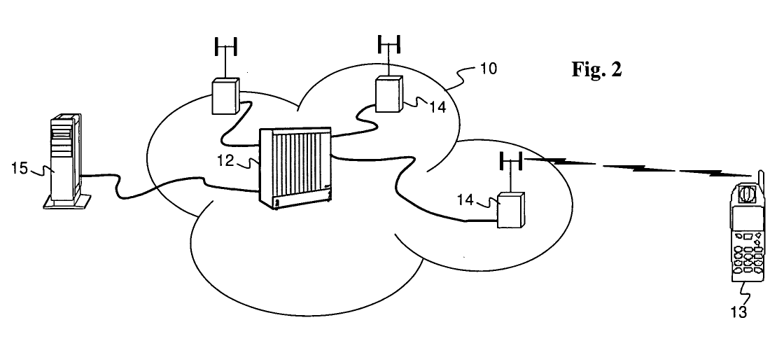

Reference is now made to FIG. 2, which is a simplified illustration of the PLMN network 10 equipped with a privately operated mobile-applications platform 15 providing a multi-modal user interface according to a preferred embodiment. As shown in FIG. 2, the privately operated mobile-applications platform is external to the PLMN network. However, the privately operated mobile-applications platform 15 can be accessed by the user of the cellular telephone 13 and can provide services in the same manner as the networked-base mobile-applications platform 11.

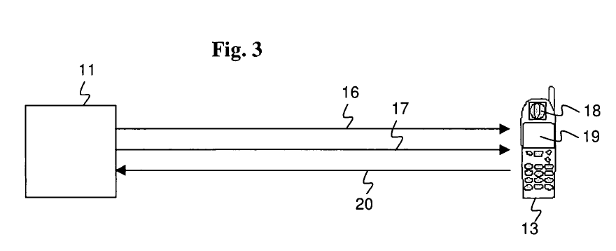

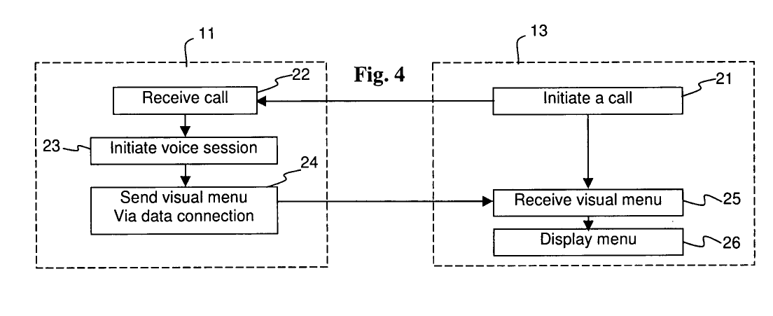

Reference is now made to FIG. 3, which is a simplified sequence diagram showing a sequence of multi-modal transmissions of service prompts and a user's response according to a preferred embodiment.

As shown in FIG. 3, the mobile-applications platform 11 preferably transmits a menu to the cellular telephone 13. The menu is transmitted simultaneously in the form of a voice prompt, as a streaming media (e.g. a streaming transmission) over a voice channel 16, and in the form of a graphical menu, as a data transmission over a data channel 17. According to a preferred embodiment of the present invention the data channel is available concurrently with the voice channel during the same call. Preferably the data channel is configured for the Unstructured Supplementary Service Data (USSD) protocol.

The cellular telephone 13 receives the streaming voice transmission and the data transmission substantially simultaneously. The cellular telephone 13 decodes the voice transmission and plays it via the earphone 18 in real time as for standard voice transmission. Simultaneously, the cellular telephone 13 processes the data transmission, composes a graphical representation of the menu as is suitable for display 19 of the cellular telephone 13, and displays the menu on the display 19. The graphical representation of the menu is adapted by the telephone software to the specific features of the display 19 such as size, resolution, colors, font type, font size, etc.

The mobile-applications platform 11 can transmit the required menu, or prompt, either in the form of a voice prompt over the voice channel 16 or in the form of a graphical menu over the data channel 17. Also, preferably both forms are used. Preferably both forms are transmitted substantially simultaneously and are presented to the user simultaneously, thus forming together a multi-modal user interface.

The user responds to the menu by sending a response 20. The user responds to either of the two forms preferably in the same manner. Namely, the user does not have to select the form of response according to any of the forms of menu presentation. Thus the user is able to respond to both modes (or forms) of presentation using keystrokes, or using speech, or any other manner. Keystrokes are typically transmitted to the mobile-applications platform 11 over a data channel, preferably the USSD, and speech is transmitted to the mobile-applications platform 11 over the voice channel.

Graphical presentation of menus and the subsequent user selection of a menu item is well know in the prior art. One preferred alternative of the graphical form, or mode, of presentation preferably uses text. Preferably the menu is a list of numbered textual items and the user can select an item by pressing the key with the number associated with the item. Alternatively the user can scroll along the text items using a scroll key and press a select key to select an item. Further alternatively the menu is presented as icons and the user can scroll along the icons using a scroll key and press a select key to select the required item. Other techniques of graphical menu presentations can also be used.

According to a preferred embodiment the data transmission carries the content of the graphical menu but not the specific graphical representation, which is determined by the software of the specific cellular telephone according to the capabilities of its display 19. Alternatively the data transmission carries the content of the graphical menu and also at least a part of the graphical representation, such as font style (bold, Italics, underline, etc.), font color, symbols and icons.

According to a preferred embodiment the data transmission also carries instructions to program soft-keys of the cellular telephone 13. When a certain key of the keypad of the cellular telephone 13 is programmed as a soft-key, preferably within the period that a specific service is used by the user, when the user presses that specific key, the software of the cellular telephone 13 automatically executes a sequence of operations, according to the soft-key program. The soft-key program is transmitted to the cellular telephone over the data channel, preferably using USSD, as a part of the multi-modal user interface.

Reference is now made to FIG. 4, which is a simplified diagram of the typical call flow between the user cellular telephone 13 and the mobile application platform 11 according to a preferred embodiment of the present invention.

As shown in FIG. 4, the call typically starts when the cellular telephone 13 initiates a call (stage 21) to the mobile application platform 11. The mobile application platform 11 receives the call (stage 22) and initiates a voice session (stage 23). While the voice connection is active, the mobile application platform 11 creates and sends a visual menu to the cellular telephone 13 (stage 24), preferably using USSD. The cellular telephone 13 receives the data communication bearing the visual menu (stage 25) and displays the menu (stage 26) concurrently with the voice session and without interruption.

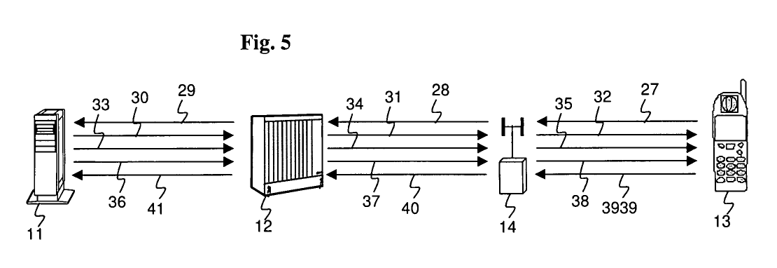

Reference is now made to FIG. 5, which is a simplified diagram of the typical call flow between the user cellular telephone 13 and the mobile application platform 11, including the MSC 12 and the base station 14, according to a preferred embodiment of the present invention.

a) A call starts when the user dials for a service provided by the mobile application platform 11. A call setup request 27 is typically transmitted to the nearest base station 14, which retransmits it (28) to the MSC 12, which forwards the call (29) to the mobile application platform 11.

b) The mobile application platform 11 answers the call (30), which results in the call completion signals from the MSC 12 (stage 31) via the base station 14 (stage 32) to the cellular telephone 13.

c) After answering the call the mobile application platform 11 sends the first menu to the cellular telephone. The menu is sent in audible format (stages 33, 34 and 35) and in graphical format (stages 36, 37 and 38), simultaneously. The signals of stages 33 and 36 proceed via the MSC 12 (stages 34 and 37) and the base station 14 (stages 35 and 38) to the cellular telephone 13.

d) The user than responds to the menu, effecting sending a response signal via the base station 14 (stage 39), via the MSC 12 (stage 40) to the application platform 11 (stage 41).

If the application contains further menus or other type of interaction with the user the process continues to stage c with the next menu. For example the application may contain a hierarchical structure of menus in which the user proceeds, for example to receive specific information.

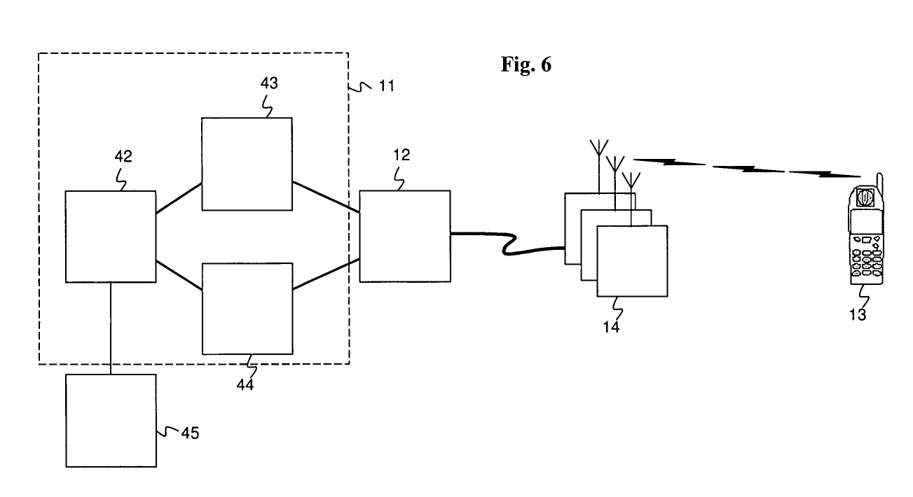

Reference is now made to FIG. 6, which is a simplified, yet more detailed, illustration of the mobile-applications platform 11 providing multi-modal user interface according to a preferred embodiment. As described in accordance with FIG. 1, the mobile-applications platform 11 of FIG. 6 is substantially identical with the mobile-applications platform 15 of FIG. 2.

As shown in FIG. 6, the mobile-applications platform 11 preferably includes an application-processing unit 42 connected to a media-processing unit 43 and a signaling unit 44, both of which are connected to the MSC 12, which is connected to a network of base stations 14.

The application-processing unit 42 is also preferably connected to a database server 45. The application-processing unit 42, the media-processing unit 43 and the signaling unit 44, as well as the database server 45 are typically independent systems interconnected via communication links, typically via a local area network such as the Ethernet. Alternatively any of the application-processing unit 42, the media-processing unit 43 and the signaling unit 44, as well as the database server 45 may be modules within the same computer system. Thus the terms “server”, “module” and “unit” are used herein interchangeably. The media-processing unit 43 provides all streaming services and especially voice streaming for transmitting voice prompts to the cellular telephone.

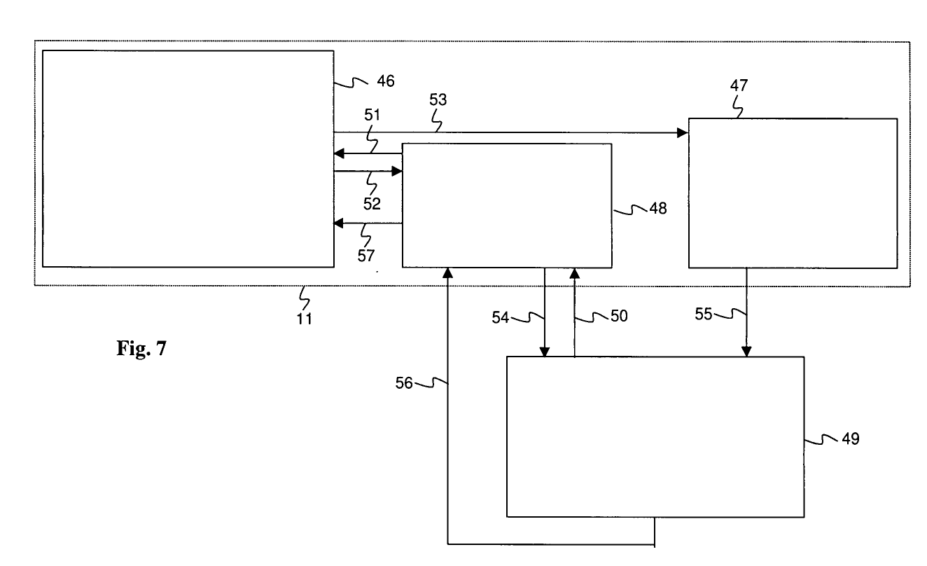

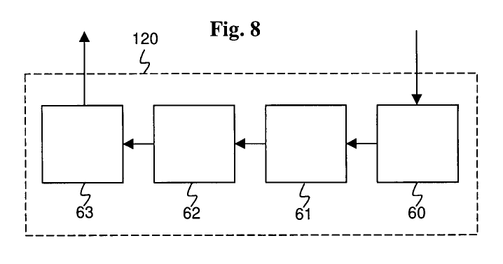

Reference is now made to FIG. 7, which is a simplified flow chart of the call flow between the main modules of the mobile-applications platform 11 and the cellular telephone 13 according to a preferred embodiment and in accordance with FIGS. 5 and 6.

As shown in FIG. 7, the call flow involves four main modules: an application processing module 46 that is executed by the application-processing unit 42, a media processing module 47 that is executed by the media-processing unit 43, which is a voice streaming unit, and a signaling module 48 that is executed by the signaling unit 44. These three modules are preferably components of the mobile application-processing unit 11. The fourth module 49 is a user client module executed by the cellular telephone 13.

The call starts when the user of the cellular telephone 13 calls the mobile application platform 11 (stage 50), or is redirected therein. The call details are received by the signaling module 48 that forwards (stage 51) the call details to the application-processing module 46. The application-processing module 46 selects a menu and communicates it to the signaling module 48 (stage 52) and to the media-processing module 47 (stage 53). The signaling module 48 (stage 54) and the media-processing module 47 (stage 55) communicate the menu to the user-client module 49. When the user makes a selection the user-client module 49 transmits the selection, preferably to the signaling module 48 (stage 56) that forwards the selection to the application-processing module 46 (stage 57).

Reference is now made to FIG. 8, which is a simplified block diagram of the user client module 58 executed by the cellular telephone 13 according to a preferred embodiment.

As shown in FIG. 8, the user client module 59 includes the following main modules:

Module 60 receives data communications bearing a visual menu from the mobile application-processing unit 11;

Module 61 extracts the menu information from the data communication;

Module 62 converts the menu information into a graphical format according to the characteristics of the cellular telephone 13, such as the size of the screen, the resolution of the screen, available colors, available fonts, etc, and displays the menu of the screen;

Module 63 enables the user to navigate through the visual menu and then collects the user response and then sends the user response to the mobile application-processing unit 11.

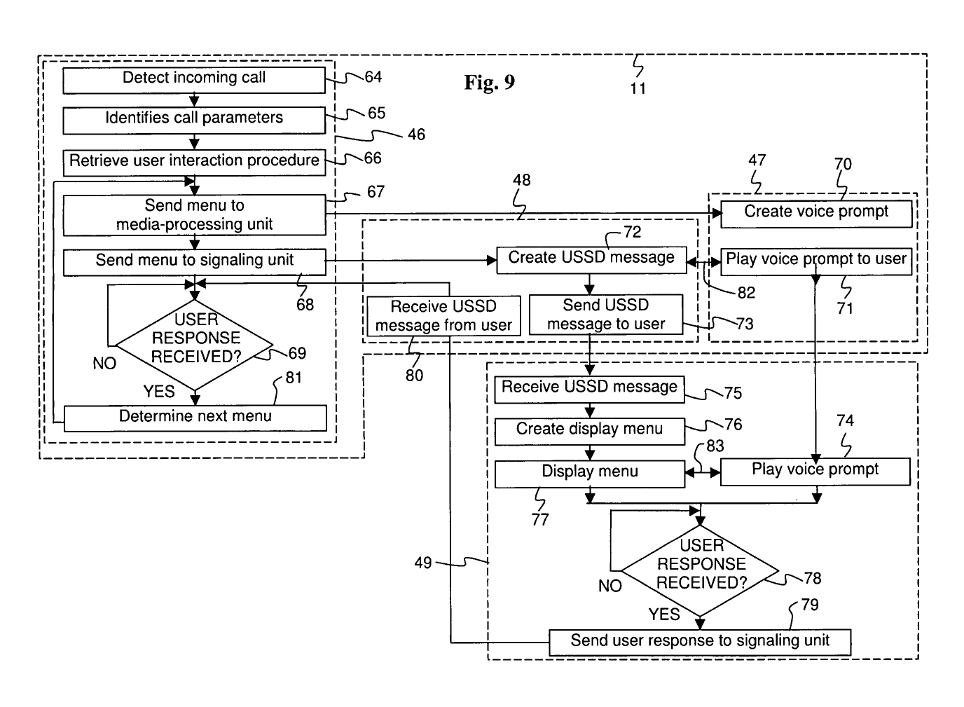

Reference is now made to FIG. 9, which is a detailed simplified flow chart of the call flow according to a preferred embodiment and in accordance with FIG. 7.

The call starts when the user of the cellular telephone 13 calls, or is redirected to, the mobile application platform 11 (stages 27, 28 and 29 of FIG. 5, which are not shown in FIG. 9). The call details are received by the signaling unit 44 that forwards the information to the application-processing unit 42. The application-processing module 46 detects the incoming call (stage 64 of FIG. 9), identifies the call parameters (stage 65 of FIG. 9) and instructs the signaling unit 44 to accept the call (stages 30, 31 and 32 of FIG. 5, also not shown in FIG. 9).

The application-processing unit retrieves from the database server information that is pertinent to the call, such as caller details (based, for example, on the identification of the cellular telephone), information associated with the dialed telephone number and session protocol (stage 66 of FIG. 9). The session protocol typically contains a hierarchical structure of menus. Typically and preferably, each menu is stored as a voice extended markup language (VXML) page.

The application-processing module 46 sends the first menu to both the media-processing module 47 (stage 67 of FIG. 9) and the signaling module 48 (stage 68 of FIG. 9), preferably simultaneously, preferably as a VXML page, preferably using Simple Object Access Protocol (SOAP). The application-processing module 46 then waits for the user's response (stage 69 of FIG. 9).

The media-processing module 47 and the signaling module 48 process the menu and send it to the client module 49 of the cellular telephone 13, preferably simultaneously. The media-processing module 48 converts the menu into a voice prompt, for example by selecting a prerecorded voice prompt, or, alternatively by assembling the voice prompts from prerecorded speech elements, or, alternatively using a text-to-speech conversion engine (stage 70 of FIG. 9). The media-processing module 48 then transmits the voice prompt to the client module 49 in streaming mode (stage 71 of FIG. 9). The signaling module 48 process the menu and converts it into an appropriate data protocol supported by the client module 49 (stage 72 of FIG. 9), and then sends the menu to the client module 49, preferably using USSD (stage 73 of FIG. 9).

The cellular telephone 13 receives the streaming voice prompt, decodes it and plays it typically via the earphone of the cellular telephone 13 (stage 74 of FIG. 9). Simultaneously, the client module 49 receives the data message from the signaling module 48 (data input module 75 of FIG. 9), converts it into a visually sensible graphical display suited for the constraints of the display of the specific cellular telephone 13 (menu extraction module 76 of FIG. 9), and displays the menu (menu display module 77 of FIG. 9). The client module 49 then enables the user to scroll through the display menu and waits for the user's response (menu response module 78 of FIG. 9). Typically and preferably, the same keystroke is provided to respond to both the voice menu and to the displayed menu. When the user's response is detected it is sent to the mobile application platform 11, preferably to the signaling module 48 (stage 79 of FIG. 9), preferably using USSD.

The signaling module 48 receives the user response and forwards it to the application-processing module 46, preferably using SOAP (stage 80 of FIG. 9).

The application-processing module 46 receives the user response (stage 69 of FIG. 9) and according to its content and the session protocol determines the next step of the session (stage 81 of FIG. 9).

Stages 67 to 81 are then repeated until the end of the session.

In a preferred embodiment, each of the options of the menu is presented simultaneously in an audibly sensible manner and in a visually sensible manner. That is, the menu is presented an option at a time, where the display of the graphical presentation of the menu, being a text or an icon, is synchronized with the verbal presentation of the same option. The synchronization can be provided at the mobile application platform by synchronizing between the media-processing unit and the signaling unit (element 82 of FIG. 9). Preferably the media-processing unit informs the signaling unit that the media-processing unit starts playing an option or finished playing an option. Alternatively the synchronization is performed in the cellular telephone (element 83 of FIG. 9) in a similar manner.

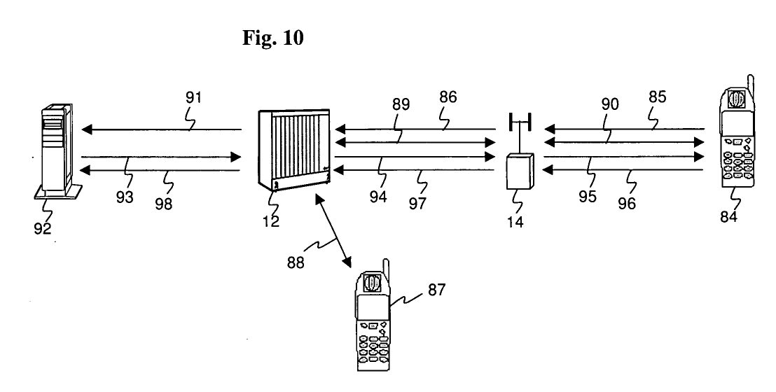

Reference is now made to FIG. 10, which is a simplified flow chart of a call flow involving transmitting a visual menu to a mobile phone during the course of a call involving a voice connection, according to a preferred embodiment of the present invention.

As shown in FIG. 10, the call typically starts when a mobile unit 84 initiates the call (stage 85, and 86) via the MSC 12, typically to another terminal of the telephone network (PLMN or PSTN), such as mobile unit 87. As mobile unit 87 answers the call a voice session is established (stages 88, 89 and 90). The MSC 12 preferably engages (stage 91) a mobile-applications platform 92 in the call, enabling the mobile-applications platform 92 to transmit menu (stages 93, 94, and 95) and receive the user selection (stages 96, 97 and 98) during the course of the voice session. It is appreciated that the exchange of menus and user responses can be performed with any of the telephone terminals engaged in the call, such as mobile units 84 and 87.

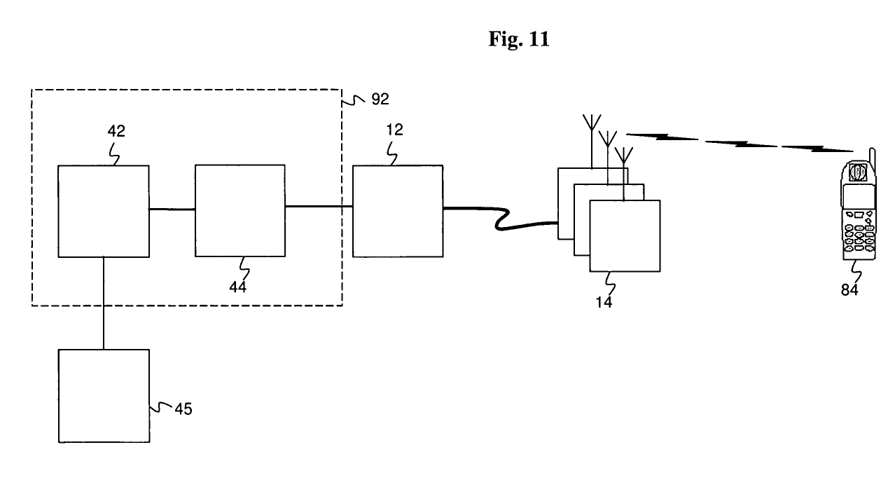

Reference is now made to FIG. 11, which is a simplified, yet more detailed, illustration of the mobile-applications platform 92 according to a preferred embodiment of the present invention.

As shown in FIG. 11, and similarly to FIG. 6, the mobile-applications platform 92 preferably the application-processing unit 42 connected to the signaling unit 44, both of which are connected to the MSC 12, which is connected to a network of base stations 14. The application-processing unit 42 is also preferably connected to the database server 45.

The application-processing unit 42 and the signaling unit 44, as well as the database server 45, are typically independent systems interconnected via communication links, typically via a local area network such as the Ethernet. Alternatively any of the application-processing unit 42 and the signaling unit 44, as well as the database server 45 may be modules within the same computer system. Thus the terms “server”, “module” and “unit” are used herein interchangeably.

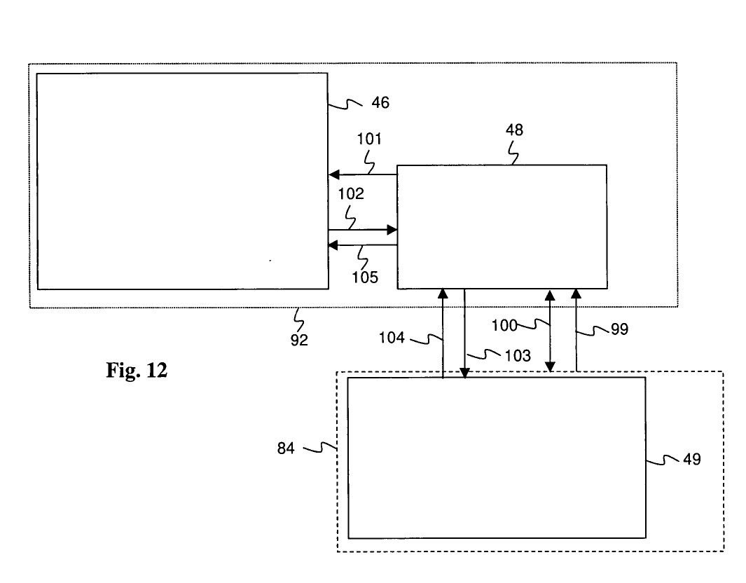

Reference is now made to FIG. 12, which is a simplified flow chart of the call flow between the main modules of the mobile-applications platform 92 and the cellular telephone 84 of FIG. 11, according to a preferred embodiment and in accordance with FIGS. 10 and 11.

As shown in FIG. 12, and in a similar manner to FIG. 7, the call flow involves three main modules: the application processing module 46 that is executed by the application-processing unit 42, the signaling module 48 that is executed by the signaling unit 44, both are preferably components of the mobile application-processing unit 92, and the client module 49, which is executed by the cellular telephone 13.

The call starts when the user of the cellular telephone 84 establishes a call (stage) that results in a voice session. The call details are received by the signaling module 48 that forwards the call details to the application-processing module 46 (stage 101). The application-processing module 46 selects a menu and communicates it to the signaling module 48 (stage 102), which communicates the menu to the user-client module 49 (stage 103), preferably using USSD. When the user makes a selection the user-client module 49 transmits the selection, preferably to the signaling module 48 (stage 104), preferably using USSD. The signaling module 48 forwards the user response to the application-processing module 46 (stage 105).

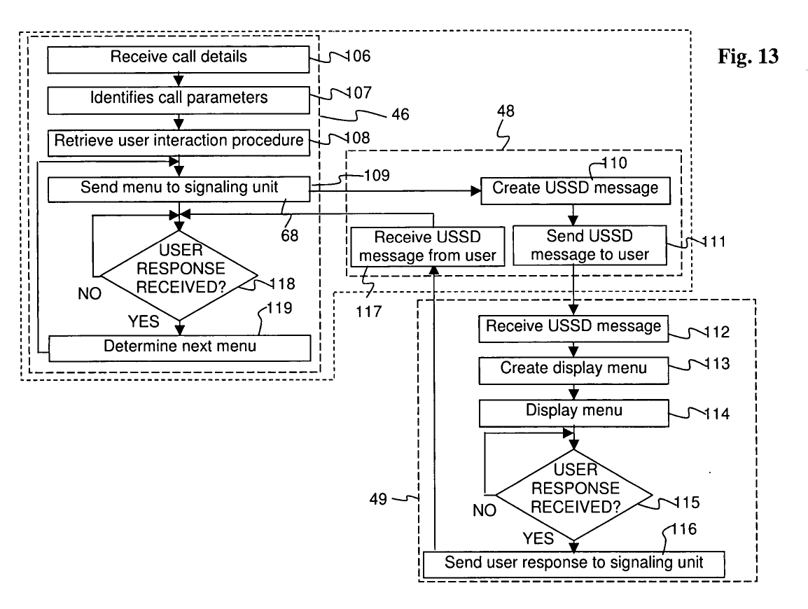

Reference is now made to FIG. 13, which is a detailed simplified flow chart of the call flow according to a preferred embodiment and in accordance with FIG. 12.

The application-processing module 46 receives the call details (stage 106), identifies call parameters (stage 107) and retrieves from the database server (stage 107) information that is pertinent to the call, such as caller details (based, for example, on the identification of the cellular telephone), information associated with the dialed telephone number and session protocol. The session protocol typically contains a hierarchical structure of menus. Typically and preferably, each menu is stored as a voice extended markup language (VXML) page.

The application-processing unit sends the first menu to the signaling unit 48 (stage 108, preferably simultaneously, preferably as a VXML page, preferably using Simple Object Access Protocol (SOAP). The application-processing unit then waits for the user's response.

The signaling module 47 processes the menu (stage 108) and sends it to the client module 48 (stage 109), preferably simultaneously, preferably using USSD.

The client module 48 receives the data message from the signaling module 47 (stage 110), converts it into a visually sensible graphical display suited for the constraints of the display of the specific cellular telephone 83 (stage 111), and displays the menu (stage 112). The client module 48 then enables the user to scroll through the display menu and waits for the user's response (stage 113). When the user's response is detected it is sent to the mobile application platform, preferably to the signaling unit (stage 114), preferably using USSD.

The signaling module 47 receives the user response and forwards it to the application-processing unit 45, preferably using SOAP (stage 115 of FIG. 7). The application processing module 45 receives the user response and, according to its content and the session protocol, determines the next step of the session (stages 116 and 117). Stages to 117 are then repeated until the end of the session.

It is expected that during the life of this patent many relevant devices and systems will be developed and the scope of the terms herein, particularly of the terms mobile application platform, application-processing unit, media-processing unit, signaling unit, streaming channel, data channel, USSD and SOAP, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A cellular telephony user interface method for enabling a user of a cellular telephone connecting to a cellular network via both a voice connection and a data connection to make a selection from a menu of options, the method comprising:
during the course of a call involving said voice connection, transmitting the menu of options as data via the data connection;
during the course of said call, converting, at the cellular telephone, the menu data into a graphical format; and
displaying said graphical format on a display of said cellular telephone.

2. A cellular telephony user interface method according to claim 1, wherein said graphical format comprises a text menu.

3. A cellular telephony user interface method according to claim 1, wherein said graphical format comprises at least one icon.

4. A cellular telephony user interface method according to claim 1, wherein said menu is transmitted via said data connection using Unstructured Supplementary Service Data (USSD).

5. A cellular telephony user interface method according to claim 1, wherein the selection is performed within a service provided via said cellular telephone, and said method further comprising:
providing said menu to said user in an audible manner via said voice connection simultaneously with said graphic display; and
accepting the selection for one of said graphical manner and said audible manner.

6. A cellular telephony user interface method according to claim 5, wherein each of said user selectable options is provided simultaneously in said audible manner and in said graphical manner.

7. A cellular telephony user interface method according to claim 5, wherein said audible manner comprises a voice menu played via an earphone of said cellular telephone.

8. A cellular telephony user interface method according to claim 5, wherein said graphical display comprises a text menu displayed on a display of said cellular telephone.

9. A cellular telephony user interface method according to claim 5, wherein said graphical display comprises a graphical menu displayed on a display of cellular telephone.

10. A cellular telephony user interface method according to claim 9, wherein said graphical menu comprises at least one icon.

11. A cellular telephony user interface method according to claim 5, wherein said menu is provided in a visually sensible manner and is transmitted to said cellular telephone via Unstructured Supplementary Service Data (USSD).

12. A cellular telephony user interface method according to claim 5, wherein said networked-based service is at least one of the:
a voice mail service;
an interactive voice response service;
an audiotex service; and
a multimedia service.

13. A cellular telephony user interface method for enabling a user to make a selection from a menu comprising a plurality of user selectable options, said method comprising:
providing the menu to said user as a streaming media;
providing the menu to said user as a non-streaming media simultaneously with said streaming media;
accepting the selection by said user of at least one of said options in response to at least one of said streaming and non-streaming media.

14. A cellular telephony user interface system operative to enable a user of a cellular telephone to make a selection from a menu comprising a plurality of user selectable options, said system comprising:
an application-processing unit operative to provide said menu to a user and to process said selection from said user;
a signaling unit associated with said application-processing unit, operative to transmit a content of said menu to said cellular telephone; and
a user client for said cellular telephone, operative to process said transmitted menu and to produce a visually sensible menu on a display of said cellular telephone;
and wherein said signaling unit is operative to transmit said menu to said user client at said cellular telephone via Unstructured Supplementary Service Data (USSD).

15. A cellular telephony user interface system operative to enable a user of a cellular telephone to make a selection from a menu comprising a plurality of user selectable options, said system comprising:
an application-processing unit operative to provide said menu and to process said selection when received from said user;
a voice-streaming unit operative to receive said menu from said application-processing unit and to transmit at least one voice prompt associated with said menu to said user via said cellular telephone;
a signaling unit operative to receive said menu from said application-processing device and to transmit said menu to said cellular telephone via a data link and to receive said selection from said cellular telephone for passing back said selection to said application-processing device; and
a user client for provision to said cellular telephone, operative to receive said menu via said data link and to produce a visually sensible menu on a display of said cellular telephone and to receive said user's selection and send said selection back to said signaling unit.

16. A cellular telephony user interface method according to claim 15, wherein at least one of said voice streaming unit and said signaling unit receive said menu from said application-processing unit using VoiceXML.

17. A cellular telephony user interface method according to claim 15, wherein at least one of said voice streaming unit and said signaling unit receive said menu from said application-processing unit using Simple Object Access Protocol (SOAP).

18. A cellular telephony user interface method according to claim 15, wherein said cellular telephone receives said menu via said data link using Unstructured Supplementary Service Data (USSD).

19. A cellular telephony user interface system according to claim 15, wherein said visually sensible manner is transmitted to said cellular telephone via Unstructured Supplementary Service Data (USSD).

20. A cellular telephone comprising a user client, said user client comprising:
a data input module for receiving data from a data link during the course of a voice call,
a menu extraction module associated with said data input module for extracting menu data from said data link,
a menu display module associated with said menu extraction module and with a screen of said cellular telephone, for displaying extracted menu data graphically on said screen during said course of said voice call, and
a menu response module for identifying user input as a selection from said menu and outputting said response.

21. A cellular telephone according to claim 20, wherein said data input module receives said menu via said data link using Unstructured Supplementary Service Data (USSD).
